(19) United States
(12) Patent Application Publication
(10) Pub. No.: US 2009/0027737 A1
(43) Pub. Date: Jan. 29, 2009

(54) METHOD FOR CORRECTING AN OVERLAP REGION AND SCANNING DEVICE

(75) Inventor: Thomas INGENDOH, Wuppertal (DE)

Correspondence Address: MCDERMOTT WILL & EMERY LLP, 600 13TH STREET, N.W., WASHINGTON, DC, 20005-3096, US

(73) Assignee: BOWE BELL & HOWELL SCANNERS, L.L.C.

(21) Appl. No.: 12/060,596

(22) Filed: Apr. 1, 2008

(30) Foreign Application Priority Data
Apr. 10, 2007 (DE) 10 2007 017 086.8
Dec. 12, 2007 (DE) 10 2007 059 766.7

(51) Int. Cl. H04N 1/04

(52) U.S. Cl. 358/474

(57) ABSTRACT

The present scanning device and related method relate to reversibly positioning markers in respective overlapping areas, where the markers are arranged in the scanning device. A control device makes x-y-position correction of a camera on the basis of a known position and a known outline of the markers. The markers are deviated and displaced from a neutral position outside scanning areas of the camera into the overlapping areas.

The invention relates first to a method for correcting an overlap region between two cameras in a scanning device, each of which preferably images an individual line, wherein the correction is performed with the aid of a marker which is provided in the overlap region, and wherein the original being scanned is disposed in a scanning plane.

A similar method is known from DE 10 2005 008 417 A1, for example. The contents of that application are hereby fully incorporated by reference into the disclosure of this application, including for purposes of adopting features of that known application into features of this application.

In the known method, the marker is disposed in the scanning plane. For purposes of correcting the overlap region it must be movable into the overlap region and then out of the overlap region again for purposes of subsequently being able to perform scanning.

The invention is concerned with the problem of how to provide a more advantageous method of correcting the overlap region.

According to a first solution, the problem is solved by the subject matter of claim 1, the basis of which is that the marker is disposed so far above the scanning plane that the two cameras still register a common point in the overlap region by means of rays which pass the marker laterally. The invention is based on the recognition that the marker need not be disposed in the scanning plane in order to be able to perform the desired correction of the overlap region. If it is disposed above the scanning plane as described, the complete image desired can still be captured. This way it is no longer necessary to move the marker out of the overlap region during scanning.

The other features of the invention are described herein below and in the specification of figures, frequently in their preferred allocation to the subject matter of claim 1, in other words the first claim made in this application, which is stated below after the description. But they may also be significant in connection with the individual features of claim 1 or of the cited objective claim, or other higher or lower ranking claims, or may have independent significance.

It is preferred when an original cover, namely a transparent original cover such as a glass or float glass cover, is provided above the scanning plane, and the marker is disposed in or above the original cover. The described method of correction can be performed with an original cover as well.

It is particularly preferred when the marker is provided in a stationary manner in or on the original cover. It does not need to be removed during scanning. The original cover therefore does not need to be moved between individual scanning processes, or in other words, in order to carry out the process of correcting the overlap region.

In this respect it is also preferred when the marker is not removed during scanning, which generally provides for easier scanner handling. A routine can run at preferred prescribed time intervals, typically when there is no original located in the device, wherein the overlap region of the adjacently arranged cameras is recorded with the aid of mathematical methods so that the recorded images can be corrected so that they fit together seamlessly and potentially without overlap.

The invention further embraces as subject matter a scanning device having two or more cameras in a side by side configuration, each of which advantageously images an individual line, said lines overlapping, and in addition having a guide for an original which is movable in a scanning plane, said cameras being disposed above the scanning plane, and in addition having a marker for purposes of correcting the overlap region.

In this respect also the prior method cited above can be referenced, which is incorporated fully into the disclosure of this application in this connection as well, accordingly, including for the purposes of incorporating the features of the known application into the claims of this application.

The object is to propose an advantageous scanning device.

This object is achieved according to a first proposal of the invention by the subject matter of claim 7, which is based on the marker being so disposed in the overlap region above the scanning plane that the two cameras beneath the marker can pick up at least one common point by means of rays which extend laterally relative to the marker. When the marker is disposed above the scanning plane, it can stay in its position even in a normal scanning process with an original lying on the scanning plane.

It is particularly advantageous when the separating device comprises a transparent original cover, and the marker is attached on or above the cover. Preferably the marker can be attached-above-on the glass or float glass original cover, for example, being etched in or glued on there, for example, further printed thereon using a screen printing technique. It is further preferred when the marker is fashioned in the form of a mark comprising at least opposing angular faces. Here it is beneficial when the marker is fashioned with a dark tint on the bottom side facing the original. It is also beneficial when the marker is fashioned with a bright color on the top surface.

With regard to the scanning device, it is preferably a device wherein the cameras each pick up only one line, preferably over a length of 12 inches, or approximately 7500 pixels, producing 1000 images per second. The original is pulled through the device rapidly accordingly.

The cameras are preferably color cameras, which register images corresponding to red, green, and blue in three adjacent lines. In connection with the proposed correction by means of the marker, the results with respect to these three lines are averaged.

The overlap region has a size of ⅛ to ⅜ of an inch, preferably ¼ inch, further approximately 4 to 5 mm. The length of the marker transverse to the direction in which the lines of the cameras extend is 1 to 4 mm, preferably 2 to 3 mm.

The invention will now be represented with the aid of the enclosed drawing, which only presents one exemplifying embodiment. Shown are:

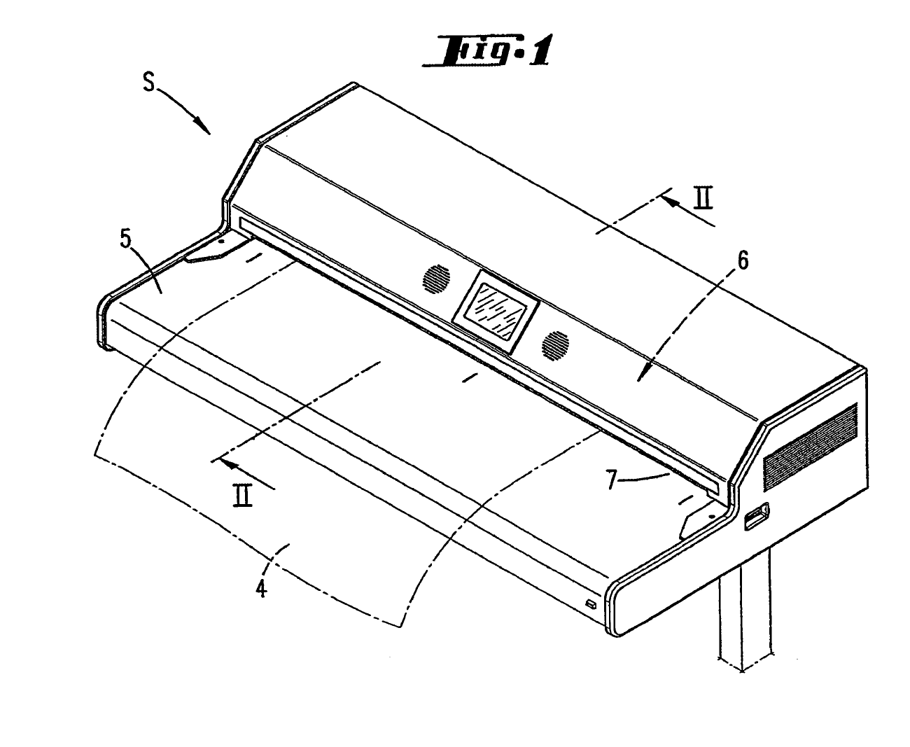

FIG. 1 a perspective view of a scanning device,

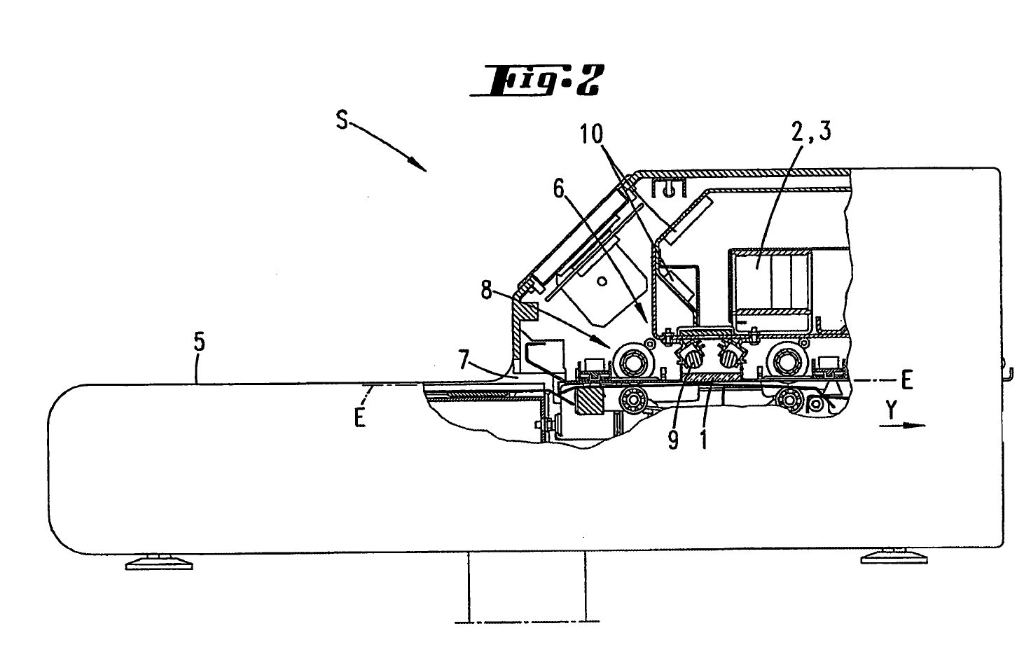

FIG. 2 a partially broken side view of the device with a slice plane according to Line II-II in FIG. 1;

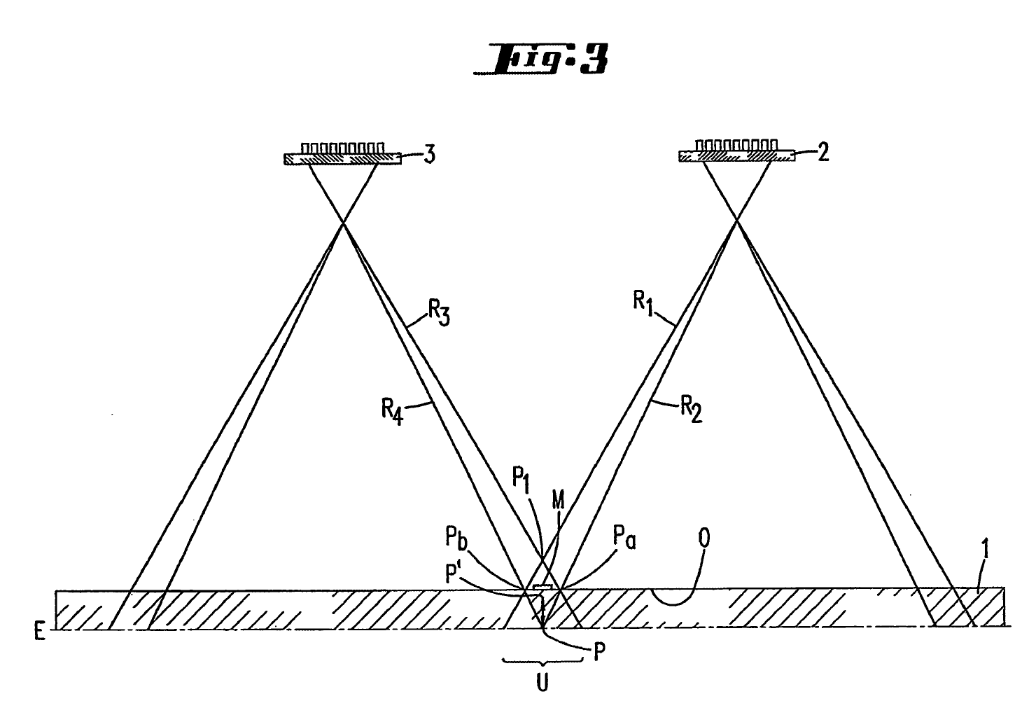

FIG. 3 a principal arrangement of two cameras of the scanning device having an overlap region with respect to their optical paths;

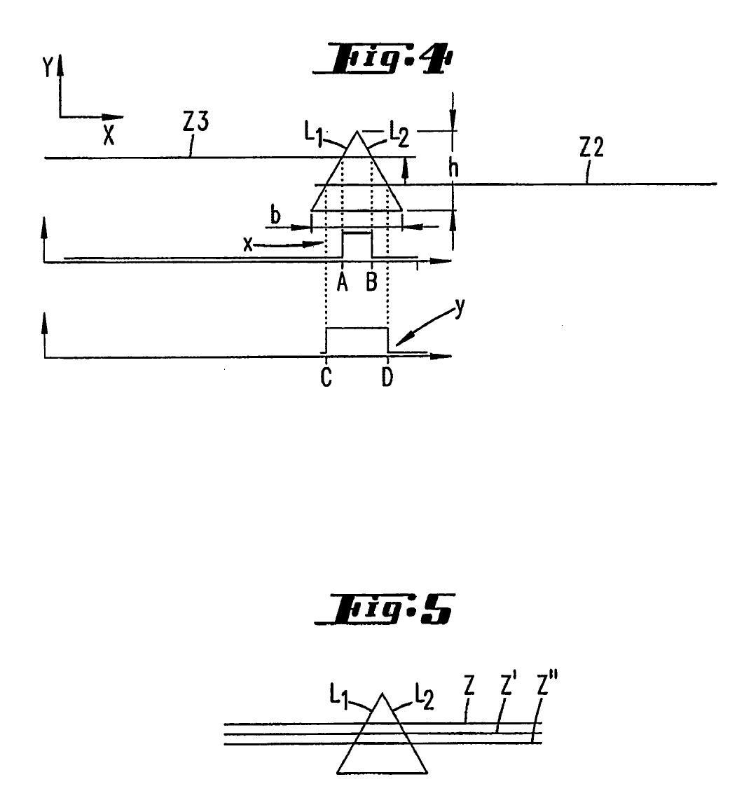

FIG. 4 an exemplifying representation of the images which are created on the basis of the marker and the corrections performed during the process and

FIG. 5 an illustration of multicolor scanning.

A scanning device S for scanning an original 4 is represented and described first with the aid of FIGS. 1 and 2.

The scanning device S comprises a flat contact portion 5 on which the original 4 is fed into the recording region 6 in a recumbent position. The contact portion 5 extends essentially within a defined scanning plane E in the recording region 6.

The original 4 is introduced into the recording region 6 through slit 7. A forward conveyor 8 in this region enables the continuous transport of the original 4 through the recording region in the Y-direction.

A transparent original cover 1 is provided above the scanning plane E in the recording region 6. Its bottom side defines the scanning plane E.

Further above the original cover 1 cameras 2 and 3 are positioned. These are line cameras, each having a CCD line sensor and capturing the original 4 line-by-line via mirrors 10.

The illumination of the original 4 during scanning is accomplished by means of an illumination unit 9, for instance in the form of a linear lamp aligned transverse to the Y-direction.

FIG. 3 shows the principal configuration in the scanning device S.

Above the original cover 1 two cameras 2, 3 are arranged in a side by side configuration, wherein only the respective CCD line sensors of each of the cameras 2, 3 are represented in FIG. 3 for ease of viewing. An original about to be scanned, which is not represented in detail in FIG. 3, is moved beneath the original cover 1, specifically perpendicular to the plane of the drawing in this example. Cameras 2, 3, each of which essentially picks up one line (but in three colors, as will be explained below), are so configured with respect to their optical path that an overlap region U emerges.

Above scanning plane E, which is defined by the bottom of the original cover 1 in this example, namely directly on the surface O of the original cover 1 in this example, a marker M is attached. In this example it is physically represented, but in practice it may be printed on the original cover 1 using a screen printing technique.

The original cover 1 can be a glass element. Normally it is a glass element made of so-called float glass.

The marker M is also shaped like an equilateral triangle in this example, as shown in FIG. 4.

With reference again to FIG. 3, exemplary edge rays R1, R2 of camera 2 and R3, R4 of camera 3 relative to marker M are represented. First, these rays meet (R2, R4), at a point P and P′ under marker M, which is discussed herein below. Second, rays R1, R3 meet at a point PI above marker M. Third, they meet at auxiliary points Pa and Pb on the side of marker M, as a result of the intersections of edge rays R2, R3 and R1, R4. Overall the points P1, Pa, Pb and P form a rhombus. The rhombus is vertical and perpendicular to the scanning plane E.

Point P′ is determined by the ray deflection still occurring inside the original cover 1 in accordance with the known laws of optics.

Rays R1 and R3 represent the outermost optical paths of the two cameras 2 and 3, respectively, relative to the overlap region U.

FIG. 3 represents two cameras 2, 3 in a side by side configuration. However, three or more side by side cameras can also be used.

The thickness of the original 1 usually amounts to several millimeters, namely 1, 2, 3, 4, 5, 6, 7 mm and so on. The preferred thickness is 4 or 5 mm. Accordingly, the marker M is located above the scanning plane E, at a distance equaling the thickness, 5 mm away, for example.

What is essential is that the marker M lie within the rhombus described by the rays R1 and R3 as outermost rays and R2 as the rays which, together with R4, still meet in the scanning plane E at point P beneath the marker M.

The bottom of marker M, which faces the original 4, is darkened, whereas the top is preferably a bright hue such as white.

As emerges from the representation according to FIG. 4, in the example given, camera 3 when displaced in the Y-direction (the transport direction of the original transverse to the scan line orientation X) relative to the recording line Z3 (the imaged line) of camera 1, two prominent points A and B emerge, due to the passage through the edge lines L1 and L2 of the in this case triangular marker. If, as in the example, the field of marker M is correspondingly tinted there between, the image will have the contour (curve x).

The image of Z2 will have the contour represented by curve y in FIG. 4, which is the distance between points C and D.

On the basis thereof it is now possible to calculate the extent to which one of the cameras is displaced relative to the other, or, if so desired, the extent to which both cameras, which is to say the imaged lines, are displaced relative to an ideal point. Accordingly, a correction of the recorded images after which the lines are matched up without gaps can usually be performed by means of a mathematical process without mechanically correcting the cameras themselves.

The difference in the widths of the initial values (curves x, y) of the individual cameras 2, 3 directly yields the Y-position error, assuming marker M is an equilateral triangle where base=height, b=h. Namely, the formula Y=(D−C)−(B−A) applies. In the exemplifying embodiment, the triangle comprises height h and a width b of 2 mm.

Preferably the cross-over point from camera 2 to camera 3 lies in the center of the triangular marker M. Thus the last point of camera 2 and the first point of camera 3 are congruent. Depending on rounding differences, one of the two can be used for the final image rendered.

The formula used to determine that point for camera 2 is: P(K2max.) is =A+(B−A)/2; i.e., the final point still recorded by camera 2. And the first point to be recorded by camera 3 is determined according to the following formula: P(K 3 min.)=C+(D−C)/2.

Due to the ray deflection in the original cover, the cross-over point may still need to be corrected. The center point of marker M is now no longer at the intersection of the two edge rays. Furthermore, the optically active displacement of the marker M relative to scanning plane E has to be determined on the basis of the original cover thickness (glass thickness) and the refractive index of the original cover (refractive index of the glass).

The relationship Δv=d*(n-1)/n applies to this image displacement Δv, in other words the displacement of P relative to P′. Here d is the thickness of the original cover, and n is the refractive index (in air). For example, in one concretely realized scanner, d=5 mm and n=1.5 mm, hence Δv is 1.67 mm. The marker M thus visually appears within the original cover (glass plate) at a distance of 3.33 mm measured from the surface of original cover. In other words, the glass thickness appears to be only 3.33 mm.

According to the laws of the intercept theorem B/G is equal to ΔB/Δa. Here B is the image width, i.e., the width of one line from point P to a corresponding point P on the opposite side, and G is the distance from the ray intersection in the lens to the originals in the scanning plane E. Given an image width of 12 inches and a value G of 449 mm, AB is 2.26 mm, which, at 600 dpi, results in a center point displacement of the triangle of approximately 27 pixels. If this displacement is factored into the calculation of the cross-over point, the resulting accuracy essentially depends only on the glass thickness.

Furthermore, in certain scanner realizations, the scanners work with cameras which image a different color (red, green, blue) in each of three adjacent lines Z, Z′, Z″. This is illustrated in FIG. 5. Accordingly, a triple value is generated for each camera, and the values can be averaged with the effect of increasing the accuracy still further.

The known color line cameras have three adjacent CCD line sensors, each having a color filter for red, green, and blue. They pick up displaced lines which are subsequently correctly repositioned by the software. The spacing is usually a few pixels. This characteristic is utilized when determining the width and position of the marker M for the purpose of increasing the accuracy.

The measurement is initially performed separately for each of the colors.

Since the distance between lines Z, Z′, Z″ is known, the measurement error due to out of range values caused by image disturbances, edges which are not entirely straight, and similar factors can be eliminated. Then the results are averaged, which further increases the accuracy, as already mentioned.

All the features disclosed are (per se) essential to the invention. The disclosure contents of the priority documents (copy of the preliminary application) are hereby also incorporated by reference into the disclosure of this application, in full, including for purposes of adopting the features of those documents into the claims of this application.

1-12. (canceled)

13. A method for correcting an overlap region between a plurality of cameras of a scanning device each of which images an individual line of an original document being scanned, the method comprising:
providing a stationary marker in the overlap region above a scanning plane;
scanning the original document in the scanning plane; and
generating a plurality of light rays by the plurality of cameras, said plurality of cameras covering a common point in the overlap region by way of the light rays passing the marker laterally.

14. The method according to claim 13, further comprising a step of:
providing an original cover in the scanning device, beneath which the original document is disposed in the scanning plane.

15. The method according to claim 13, characterized in that the stationary marker is provided on or in the original cover.

16. The method according to claim 13, characterized in that the marker is not removed during scanning of the original document.

17. The method according to one claim 13, characterized in that the plurality of cameras scan multiple lines of the original document in parallel, each line being captured in red, blue, and green colors.

18. A scanning device comprising:
a plurality of cameras provided in a side by side configuration above a scanning plane through which an original document is movable by way of a guide, the cameras being adapted to capture an image of the document line-by-line; and
a marker disposed in an overlap region above the scanning plane, wherein the plurality of cameras are configured to scan at least one common point under the marker by way of light rays which extend laterally relative to the marker.

19. The scanning device according to claim 18, further comprising a transparent original cover.

20. The scanning device according to claim 18, wherein the marker is attached to the original cover.

21. The scanning device according to claim 18, wherein the marker comprises opposing angular faces.

22. The scanning device according to claim 18, wherein the marker includes a darkened bottom surface facing the original document.

23. The scanning device according claim 18, wherein the marker includes a lightened top surface facing away from the original document.

24. The scanning device according to claim 18, wherein the marker is printed on the original cover by way of a screen printing technique.
